(19) United States
(12) Patent Application Publication
(10) Pub. No.: US 2019/0005927 A1
(43) Pub. Date: Jan. 3, 2019

(54) KEY CAP FOR FLUTE

(71) Applicant: CIEL CO., LTD., Wonju-si Gangwon-do (KR)

(72) Inventors: Chang Gyun SHIN, Wonju-si (KR); Ha na JEON, Wonju-si (KR)

(21) Appl. No.: 16/063,395

(22) PCT Filed: Nov. 1, 2016
(86) PCT No.: PCT/KR2016/012447

§ 371 Date: Jun. 18, 2018

(30) Foreign Application Priority Data
Dec. 21, 2015 (KR) 10-2015-0183126

(51) Int. Cl. G10D 9/04; G10D 7/02

(52) U.S. Cl. CPC G10D 9/043; G10D 7/026

(57) ABSTRACT

The present invention relates to a flute key cap with an auxiliary key piece which allows even children with small hands to facilitate flute performance. In particular, the present invention relates to a flute key cap including: a key cover having a hollow interior with an open bottom corresponding to a shape of a flute key; and an auxiliary key piece formed on an upper surface of the key cover.

### BACKGROUND OF THE INVENTION

### 1. Technical Field

The present invention relates to a key cap for a flute, and more particularly to a key cap having an auxiliary key piece for a child with a short finger length

### 2. Description of Related Art

A flute, which is one of wind instruments, is generally characterized by uniform characteristics in all range. Basic tones of the flute are also made to have a feel as if it moves like smoke because of its special vibration, and a player directly adjusts the amount of breathing and the degree of vibration by using the player's lips. Accordingly, the flute can be said to have an absolute influence of the player on characteristics of the sound. In addition, the flute is a musical instrument that has advantages in which the player not only gives a cheerful feeling and power to the sound, but also can play a soft flowing melody as well as to have enough emotional breadth.

Such flutes are classified into a French open key type and a German type covered key type depending on whether or not a key on a tone hole for adjusting is pierced. These flutes are initially made of wood, but most of them are plated with nickel or silver for most of these days, and some parts are made of silver for the performance, or the whole is made of silver, gold or platinum.

Further, the flute includes a head joint positioned at one end to include a head screw capable of adjusting the volume and a mouth piece for injecting the air by using the lips, and a body joint and a foot provided with a plurality of holes or adjusting the pitch.

Since the flute is light-weighted and is small in size, the flute has not only been loved for a long time, but more and more people are trying to learn flute in recent years.

In particular, young children are learning a lot of flutes early, and children are increasingly trying to learn flutes from their early childhood due to the admission system that recently recognizes special students.

However, these flutes are often used by younger children to give up learning because of physical differences or to wait until they are 9 years old and have learned fundamentals using an alternative instrument, e.g. a fife or a recorder.

In addition, since the use of the fife or recorder is not suitable for education because its function and sound are not suitable for education, foreign countries use a piccolo or infant exclusive flute, but the price of a piccolo or infant-exclusive flute is expensive.

Accordingly, when a child grows up to be a highly educated child whose physical differences are resolved, he or she will play using a common flute. Young children between the ages of 5 and 7 and 9 were playing with the infant-exclusive flute and later on with the common flute.

Therefore, since it is necessary to purchase the expensive flute early in the early stage, such as early childhood, and purchase the common flute after the growth, this an economic burden that makes early education hesitant.

### SUMMARY

An object of the present invention is to solve the aforementioned problems and other problems. Another object is to provide a key cap for a flute, which can be easily attached to and detached from the flute and in which no problem occurs during performance.

Technical objects desired to be achieved in the present invention are not limited to the aforementioned objects, and other technical objects not described above will be apparent to those skilled in the art from the disclosure of the present invention.

For achieving the objects or other objects, an aspect of the present invention provides a key cap for a flute, including: a key cover configured to have a hollow interior with an open bottom corresponding to a shape of a flute key; and an auxiliary key piece formed on an upper surface of the key cover.

A center of the auxiliary key piece may be spaced by a predetermined distance from a center of the key cover.

The key cover may include: a top surface that contacts a top surface of the flute key; and a circumferential portion that contacts a side surface of the flute key, to cover the flute key.

The circumferential portion may have at least one groove formed for preventing interference of keys adjacent to the flute key.

The circumferential portion may have at least one groove formed for preventing the interference of the body joint.

The circumferential portion may have at least one groove for preventing interference with a connector of the flute key.

The circumferential portion may further include a hook portion protruding inwardly from a lower end of the circumferential portion.

A center of the auxiliary key piece is spaced from a center of the key cover in a predetermined direction, and the hook portion is provided at a lower end of the circumferential portion in an opposite direction to the predetermined direction.

In the circumferential portion, the second interference-preventing groove, the hook portion, and the third interference-preventing groove are sequentially formed at a position where the auxiliary key piece is provided, based on a clockwise direction.

### Advantageous Effects

An effect of the flute key cap according to the aspect of the present invention will be described as follows.

According to at least one of exemplary embodiments of the present invention, even young children those fingers are relatively short may play adult flutes.

In addition, according to at least one of the exemplary embodiments of the present invention, it is possible to smoothly play a flute while easily fitting and removing the key cap.

An additional range of applicability of the present invention will become clear from the following detailed description. However, since various modifications and alternations within the spirit and scope of the present invention may be clearly understood by those skilled in the art, it is to be understood that a detailed description and a specific exemplary embodiment of the present invention such as an exemplary embodiment of the present invention are provided only by way of example.

### BRIEF DESCRIPTION OF THE DRAWINGS

FIG. 1 is a schematic diagram illustrating a whole body of a general flute.

FIG. 2 is a cress-sectional view taken along a line A-A for describing an internal structure of a flute key.

FIG. 3 is a cross-sectional view taken along a line B-B for describing an internal structure of a flute key.

FIG. 4 is a perspective view of a key cap 200 for a flute according to an exemplary embodiment of the present invention.

FIG. 5 shows a top view and a bottom view of the key cap 200 according to an exemplary embodiment of the present invention.

FIG. 6 shows left and right perspective views of the key cap 200 in an inverted state according to an exemplary embodiment of the present invention.

FIG. 7 shows a side view of the key cap 200 according, to an exemplary embodiment of the present invention.

FIG. 8 is a view for describing a role of an interference-preventing groove 230-1 according to an exemplary embodiment of the present invention.

FIG. 9 illustrates state views before and after the key cap 200 is put on third and fourth keys 173 and 174 according to an exemplary embodiment of the present invention.

FIG. 10 shows views for describing a relative position of a hook portion 270 which can be easily removed without interference with flute performance according to an exemplary embodiment of the present invention

FIG. 11 illustrates a change in the left-handed fingernail before and after the key cap 200 is covered according to an exemplary embodiment of the present invention.

### DETAILED DESCRIPTION OF THE INVENTION

Hereinafter, exemplary embodiments disclosed in the present specification be described in detail with reference to the accompanying drawings. In the present specification, the same or similar components will be denoted by the same or similar reference numerals, and a repeated description thereof will be omitted. Terms “unit” for components used in the following description are used only in order to easily make a specification. Therefore, these terms do not have meanings or roles that distinguish them from each other in themselves. In addition, the accompanying drawings are provided only in order to allow exemplary embodiments disclosed in the present specification to be easily understood and are not to be interpreted as limiting the spirit disclosed in the present specification, and it is to be understood that the present invention includes all modifications, equivalents, and substitutions without departing from the scope and spirit of the present invention.

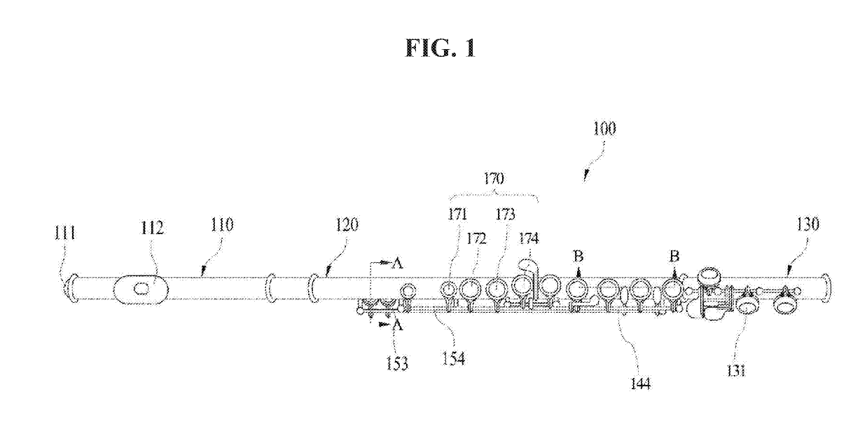

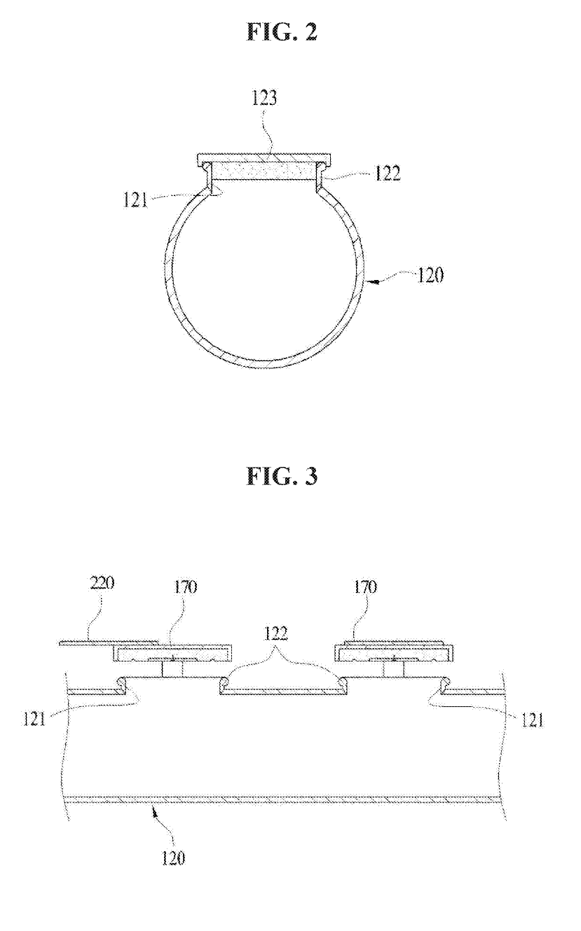

FIG. 1 is a schematic diagram illustrating a whole body of a general flute 100.

In addition, the flute 100 is formed to include a head joint 110 positioned at one end to include a head screw 111 capable of adjusting the volume and a mouthpiece 112 for allowing air to be injected by using the lips, a body joint 120 connected and coupled to the head joint 110 to have a plurality of holes 121 drilled for to adjust the pitch, a foot joint 130 connected and coupled to the body joint 110 such that a key assembly 131 for adjusting tone is coupled thereto, and a flute key 170 for opening and closing the holes 121 of the body joint 120.

The head screw is rotationally coupled to one end of the head joint 110 for adjusting the volume to form the mouthpiece 112 or injecting air. The head joint 110 is generally formed in a straight-line shape as illustrated FIG. 1, but may be formed by being bent by 180° in the case of a head joint for children.

The body joint 120 may have the holes 121 drilled for adjusting the pitch.

The holes 121 of the body joint 120 may protrude a guide 122 to constantly maintain cross-sections of the holes 121, a blocking cork or silicon pad may be attached to a stopper 123 to completely close and seal trill key holes 121.

The foot joint 130 is connected, and coupled to the body joint 110 and is coupled to the key assembly 131 for adjusting the tone. When used, the foot joint 130 may be connected to the body joint 120.

In addition, the main key 170 is connected to a connection rod so as to be interlocked with each other, and the connection rod 144 is coupled to a supporting ball 145 to be rotated. In this case, it is resiliently installed by coupling a spring to the connection rod 145.

In general, the flute key 170 may include first to fourth keys 171 to 174 which are opened and closed by using a left finger. According to left-fingering of the first to fourth keys 171 to 174 for playing the flute, the first key 171 is pressed with a left index finger, and the third key 17 and the fourth key 174 are respectively pressed by a middle finger and a ring finger as shown in FIG. 9(a).

However, in the case of a child with a short finger length, the distance between the keys is too long to learn the fingering. Thus, unless you buy a flute for children separately, it is difficult for a child to learn the flute. Therefore, in the exemplary embodiment of the present invention, it is proposed to install a key cap for providing auxiliary key pieces in at least one key among the flute keys 170

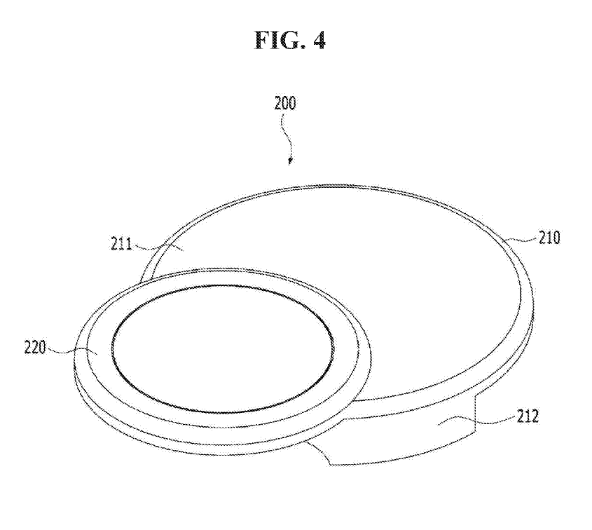

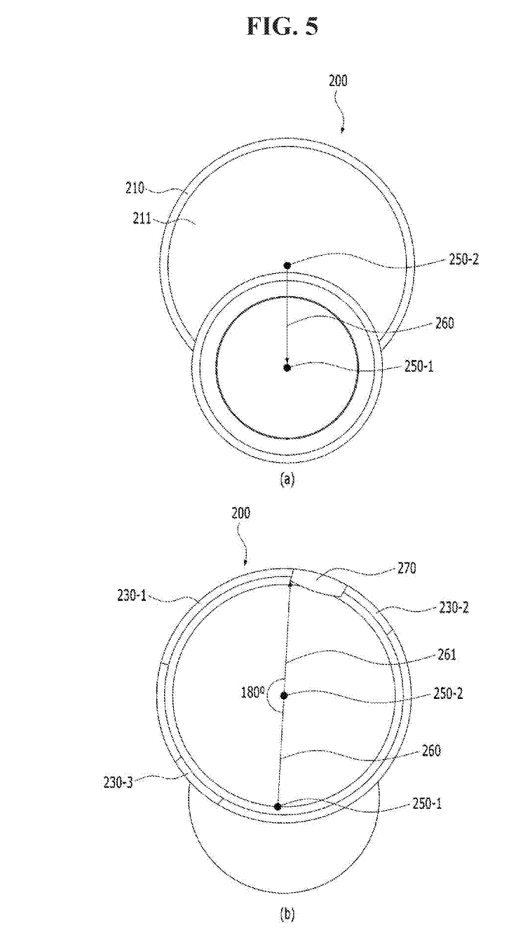

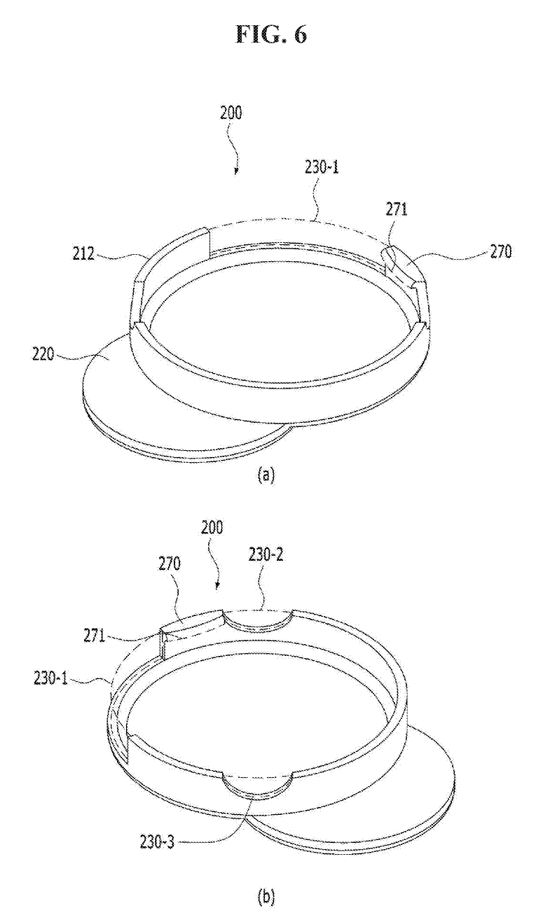

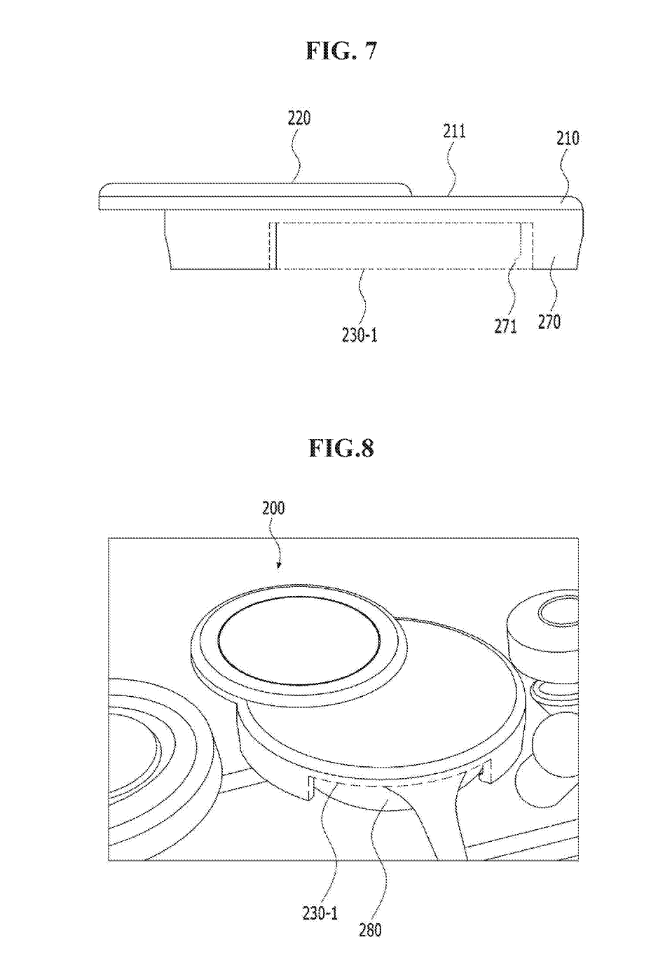

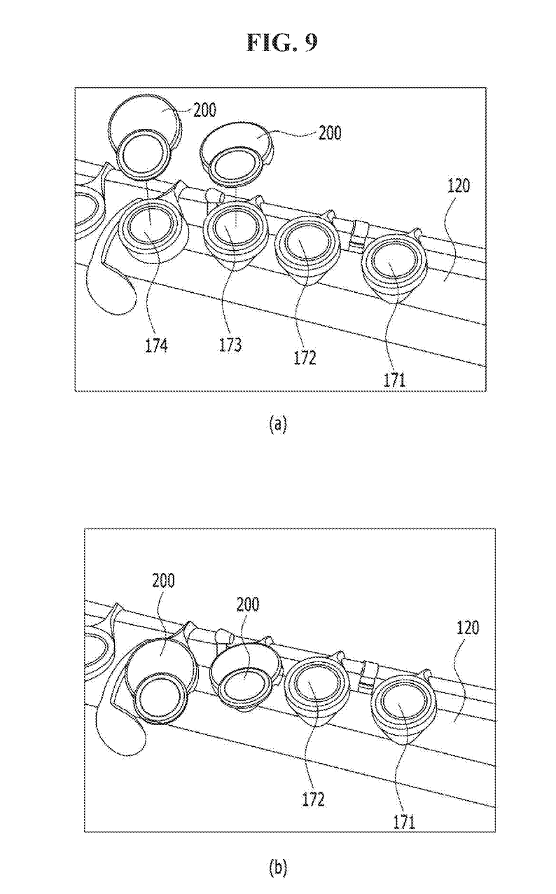

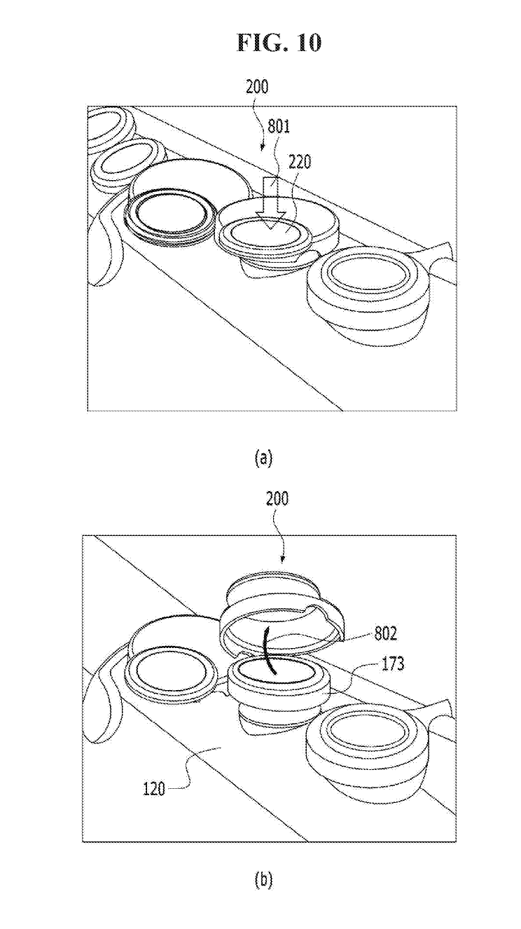

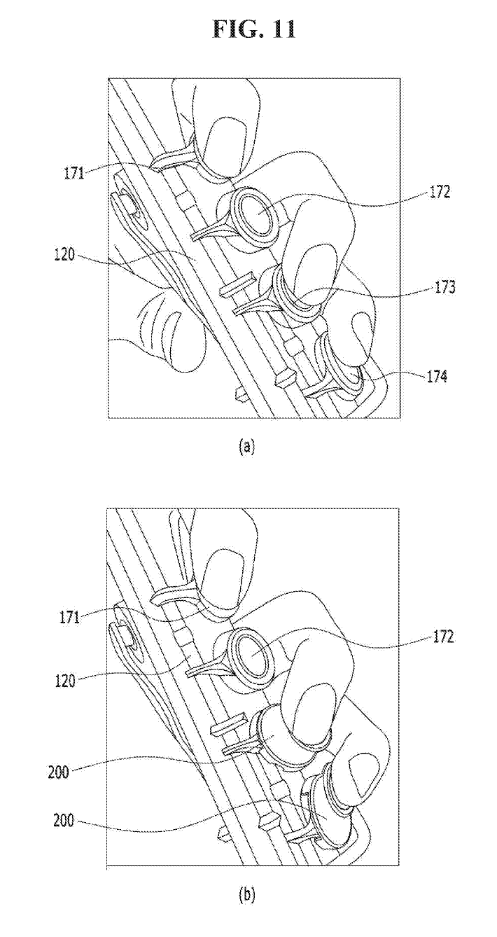

FIG. 4 is a perspective view of a key cap 200 for a flute according to an exemplary embodiment of the present invention. FIG. 5 shows a top view and a bottom view of the key cap 200 according to an exemplary embodiment of the present invention. FIG. 6 shows left and right perspective views of the key cap 200 in an inverted state according to an exemplary embodiment of the present invention. FIG. 7 shows a side view of the key cap 200 according to an exemplary embodiment of the present invention. FIG. 8 is a view for describing a role of an interference-preventing groove 230-1 according to an exemplary embodiment of the present invention. FIG. 9 illustrates state views before and after the key cap 200 is put on third and fourth keys 173 and 174 according to an exemplary embodiment of the present invention. FIG. 10 shows views for describing a relative position of a hook portion 270 which can be easily removed without interference with flute performance according to an exemplary embodiment of the present invention. FIG. 11 illustrates a change in the left-handed fingernail before and after the key cap 200 is covered according to an exemplary embodiment of the present invention.

According to illustrated drawings, the flute key cap 200 according to the present exemplary embodiment may include a key cover 210 having a hollow interior with an open bottom corresponding to a shape of the flute key; and an auxiliary key piece 220 formed on an upper surface 211 of the key cover 210.

Referring to FIG. 5, a center 250-1 of the auxiliary key piece 220 may be spaced by a predetermined distance from a center 250-2 of the key cover 210.

The key cover 210 may include: a top surface that contacts a top surface of the flute key; and a circumferential portion 212 that contacts a side surface of the flute key, so as to cover the flute key.

The circumferential portion 212 may have at least one groove formed for preventing the interference of keys adjacent to the flute key.

The circumferential portion 212 may have at least one groove 230-2 and 230-3 formed for preventing the interference of the body joint 120. Specifically, when a key is pressed in a state in which the flute key cap 200 is fitted in (covered with) the flute key according to the present exemplary embodiment, a part of the key cap circumferential portion 212 may interfere with the body joint 120. Accordingly, in the present exemplary embodiment, as illustrated therein, two grooves 230-2 and 230-3 may be formed. In this case the two grooves 230-2 and 230-3 may be formed opposite to each other with respect to the center 250-2 of the key cover 210 (see FIG. 5(b)).

As illustrated in FIG. 8, the circumferential portion 212 may have at least one groove 230-1 for preventing the interference with a connector 280 of the flute key.

The circumferential portion 212 may further include a hook portion 270 protruding inwardly from a lower end of the circumferential portion 212. Generally, in the case of musical instruments, the tone changes sharply even in a small variation. For this reason, the key itself should not be deformed or overloaded in the process of engaging and disengaging the key cap on the key of the flute.

Therefore, the present exemplary embodiment suggests a structure of a key cap that can be fitted in and removed from a flute key easily without interference in instrument performance.

As illustrated therein, a center 250-1 of the auxiliary key piece 220 is spaced from the center 250-2 of the key cover 210 by a predetermined distance in a predetermined direction. When playing the flute in a state of being covered by the key cap, a player plays the flute by pressing the auxiliary key piece 220 (pressure in a direction 801 in FIG. 10(a)). In this case, an opposite direction 261 of the auxiliary key piece 220 is raised by the principle of leverage. Therefore, in the present exemplary embodiment, a position of the hook portion 270 is limited in order to suppress this raising phenomenon.

Specifically, in the present exemplary embodiment, the center 250-1 of the auxiliary key piece 220 is spaced from the center 250-2 of the key cover 210 in a predetermined direction 260, and the hook portion 270 may be provided at a lower end of the circumferential portion 212 in an opposite direction 261 to the predetermined direction 260.

When the hook portion 270 is provided in a direction that is different from the aforementioned direction, the key itself may be deformed or unstable during the process of fitting and removing the key cap. Moreover, it may not certainly prevent the raising phenomenon when the auxiliary key piece 220 is pressed. Accordingly, as in the present exemplary embodiment, the hook portion 270 may be formed at a position in the opposite direction 261 (about 180 degrees) to the direction 260 from the center 250-2 of the key cover to the center 250-1 of the center 250-1 of the auxiliary key piece 220. As a result, no hook is formed at a position (point or direction) other than the hook portion 270. This is to easily perform the fitting and removing operations without interference in instrument performance.

As illustrated in FIG. 10, in the hook portion 270 formed in this way, the key cap 200 may not be removed or raised even though a pressure is applied in a direction 801. When the auxiliary key piece 220 is held and pushed in an upward direction 802 as illustrated in FIG. 10(b), the key cap 200 may be easily removed without damaging or straining the flute key.

Referring to FIG. 6, in the circumferential portion 212, the first interference-preventing groove 230-3, the second interference-preventing groove 230-1, the hook portion 270, and the third interference-preventing groove 230-2 may be sequentially formed at a position where the auxiliary key piece is provided, based on a clockwise direction. Grooves thus formed may prevent any interference caused by the key cap 200 when a player plays the flute.

The above detailed description is not to be interpreted as being restrictive, but to be considered as being illustrative. The scope of the present invention is to be determined by a reasonable interpretation of the claims, and all alternatives within equivalents of the present invention fall within the scope of the present invention.

1. A key cap for a flute, comprising:
a key cover (210) having a hollow interior with an open bottom corresponding to a shape of a flute key; and
an auxiliary key piece (220) formed on an upper surface (211) of the key cover (210).

2. The key cap of claim 1, wherein a center (250-1) of the auxiliary key piece (220) is spaced by a predetermined distance from a center (250-2) of the key cover (210).

3. The key cap of claim 2, wherein the key cover (210) includes:
a top surface that contacts a top surface of the flute key; and
a circumferential portion (212) that contacts a side surface of the flute key,
to cover the flute key.

4. The key cap of claim 3, wherein the circumferential portion (212) has at least one groove formed for preventing interference of keys adjacent to the flute key.

5. The key cap of claim 3, wherein the circumferential portion (212) has at least one groove (230-2) and (230-3) formed for preventing the interference of the body joint (120).

6. The key cap of claim 3, wherein the circumferential portion (212) has at least one groove (230-1) for preventing interference with a connector (280) of the flute key.

7. The key cap of claim 3, wherein the circumferential portion (212) further includes a hook portion (270) protruding inwardly from a lower end of the circumferential portion (212).

8. The key cap of claim 7, wherein:
a center (250-1) of the auxiliary key piece (220) is spaced from a center (250-2) of the key cover (210) in a predetermined direction (260); and
the hook portion (270) is provided at a lower end of the circumferential portion (212) in an opposite direction (261) to the predetermined direction (260).

9. The key cap of claim 8, wherein, in the circumferential portion (212), the second interference-preventing groove (230-1), the hook portion (270), and the third interference-preventing groove (230-2) are sequentially formed in a clockwise direction from a position where the auxiliary key piece is provided.
